(19) United States
(12) Patent Application Publication
(10) Pub. No.: US 2010/0196573 A1
(43) Pub. Date: Aug. 5, 2010

(54) METHOD FOR THE PRODUCTION OF SUGAR SUBSTITUTE SYRUPS

(76) Inventor: Alois Thelen, Baesweiler (DE)

Correspondence Address: Briscoe, Kurt G.;Norris McLaughlin & Marcus, PA, 875 Third Avenue, 8th Floor, New York, NY, 10022, US

(21) Appl. No.: 12/602,661

(22) PCT Filed: Feb. 11, 2008
(86) PCT No.: PCT/EP08/51623

§ 371 Date: Dec. 2, 2009

(30) Foreign Application Priority Data
Feb. 15, 2007 (DE) 10 2007 008 056.7

(51) Int. Cl. A23L 1/236; A23L 1/09

(52) U.S. Cl. 426/548; 426/520

(57) ABSTRACT

The present invention relates to a vacuum boiling process for the preparation of substitute syrups including a vacuum filling operation, syrups obtainable by such process, the use thereof, and products obtainable from such syrups.

The present invention relates to a vacuum boiling process for the preparation of substitute syrups including a vacuum filling operation, syrups obtainable by such process, the use thereof, and products obtainable from such syrups.

Sugar substitutes, such as isomalt and erythritol, are crystalline compounds having a limited solubility, or the solutions/syrups thereof have a strong tendency to crystallization. In the case of isomalt, a syrup exists only at elevated temperature, i.e., only at temperatures of above 70° C. Of erythritol, stable solutions and syrups are not known. Therefore, these sugar substitutes are difficult to process since a solution or syrup is indispensable for a wide variety of applications.

It has now been found that such sugar substitutes yield stable solutions/syrups when cooked, i.e., heated, followed by cooling under reduced pressure. These solutions are then stable even under normal pressure over extended periods of time. Thus, the application relates to:

(1) a process for the preparation of stable solutions/syrups of sugar substitutes including:
(a) heating an aqueous solution or suspension of a sugar substitute or a solid sugar substitute for a time and at a temperature sufficient to obtain a clear syrup of the sugar substitute; and
(b) cooling the syrup obtained under (a) under reduced pressure;
   (2) a syrup of a sugar substitute obtainable by the process described under (1);
   (3) the use of the syrup of the sugar substitute as defined under (2) for the preparation of base materials and products suitable for the preparation of foods and fodders; and
   (4) base materials and products obtainable by processing a syrup as defined under (2).

Sugar substitutes within the meaning of the present invention include, in particular, erythritol (meso-1,2,3,4-butanetetrol), isomalt (Platinit®, isomaltitol, 6-O-α-D-glucopyranosyl-D-glucitol) etc.

For the process (1) of the present invention, in the case of erythritol, it is preferred for the concentration or content of erythritol in the solution of step (a) to be smaller than or equal to 80% by weight. More preferably, it is from 30 to 70% by weight. For isomalt, both a commercially available, i.e., essentially anhydrous, isomalt formulation and an aqueous isomalt solution having an isomalt content of greater than or equal to 50% by weight, preferably greater than or equal to 70% by weight, can be employed.

The heating of the solution of the sugar substitute in step (a) is preferably effected at 80° C. to 100° C. with a mild heat input, for example, on a water bath. Said sufficient time is essentially determined by the concentration and solubility of the sugar substitutes in the respective aqueous medium. Usually, it is within a range of from 10 minutes to 2 hours. Alternatively, said heating may also be effected by a rapid direct addition of heat, in which higher temperatures than those used in said mild heating may occur in the solution or syrup, especially when a solid sugar substitute is heated.

In a particular embodiment of the process according to the invention, the heating of step (a) is also effected under a slight vacuum.

In the process according to the invention, said cooling under reduced pressure is effected by closing a container comprising the heated syrup obtained in step (a). Additionally, a slight vacuum may be applied to said container comprising the heated syrup. Additionally may be effected.

The thus obtained syrups of sugar substitutes are probably undercooled melts that are stable under vacuum for an extended period of time. Even after breaking the vacuum, the cooled syrups are stable over a period of several hours, so that they can be further processed without difficulty.

The use of the syrup of a sugar substitute for the preparation of base materials and products suitable for the preparation of foods and fodders can be effected as described in PCT/EP2006/068857, which is included herein by reference. Such base materials and products essentially consist of (i) a powder selected from a thickener, lecithin powder, a mixture of several thickeners and a mixture of one or more thickeners with lecithin (hereinafter referred to as “powder”), and (ii) a syrup and a mixture of different syrups as obtainable by the process of the present invention. Such a base material is employed for the preparation of foods, food supplements, food precursors, fodders, fodder supplements, fodder precursors, pharmaceuticals, veterinary medicaments or cosmetics, preferably for the preparation of fodders, fodder precursors, foods or food precursors, more preferably for the preparation of foods or food precursors. Such a base material can be prepared by a process comprising the following steps:

(i) joining the powder and the syrup; and
(ii) mixing, preferably kneading, the mixture, preferably at room temperature, until a homogeneous composition is obtained.

The weight ratio of powder to syrup is preferably from 1:0.2 to 1:2, more preferably from 1:0.4 to 1:2, even more preferably from 1:0.6 to 1:1.5. Based on 100 g of powder, this means a proportion of preferably from 20 g to 200 g of syrup, more preferably from 40 g to 200 g of syrup, even more preferably from 60 g to 150 g of syrup. Especially the mixture of 100 g of powder plus 80 g of syrup is excellently suitable as a base composition for further uses and is therefore most preferable. The powder includes, in particular, starch flour, preferably corn starch, potato starch, wheat starch, rice starch or soybean starch.

The present invention is further illustrated by the following Examples. These are not, however, intended to limit the invention.

### EXAMPLES

### Example 1

### Comparative Example

Heating a mixture of water and erythritol (Eridex 16954, Cargill) at a ratio of 100 to 75 (75 g of erythritol per 100 g of water) at a boiling temperature of 90° C. yielded a syrupy solution from which the erythritol crystallized out immediately upon cooling under normal pressure.

### Example 2

On a water bath (a 2.5 liter kettle with a standing screen), a mixture of water and erythritol at a ratio of 100 to 75 (75 g of erythritol per 100 g of water) in a preserving jar was heated to boil for 80 min. After about 80 min, the erythritol has completely dissolved in the water. Slow cooling to room temperature while maintaining the vacuum on the syrup in the preserving jar yields a colorless viscous syrup, which retained its consistency for more than 10 days without crystallization of the erythritol.

With a comparable experimental design, the preserving jar was opened after the cooling (about 8 hours) and the vacuum thus broken. After about 8 hours in normal ambient air, the first crystals formed. A subsequent filtering process yielded a clear solution, the weight of the crystals filtered off being 0.67 g and 256 g of clear erythritol liquid being obtained. After another 11 days, a renewed occurrence of crystal formation was observed, though to a lesser extent.

### Example 3

Example 2 was repeated with changed mixing ratios as stated below.

| Erythritol/ | water | |
|---|---|---|
| 75 g/ | 10 g | negative/immediate crystallization upon cooling |
| 75 g/ | 30 g | negative/crystallization upon cooling after about 1 hour |
| 75 g/ | 40 g | positive/homogeneous for more than 12 hours |
| | | (experiment still running) |
| 75 g/ | 50 g | positive/homogeneous for more than 36 hours |
| | | (experiment still running) |
| 75 g/ | 75 g | positive/homogeneous for more than 48 hours |
| | | (experiment still running) |

### Example 4

In a pot, a mixture of water and erythritol at a ratio of 100 to 75 was heated to 90° C. in a pot with constant stirring and, when bubbles formed, cooked for 2.5 min. The boiling liquid was poured into a temperature-controlled jar, sealed airtight with a lid and subsequently turned upside down for some minutes for sterilization and vacuum generation. After about 12 hours, a slight crystallization occurred, which could be stopped by a filtering process as described in Example 2. After 11 days, crystal formation begun again.

### Example 5

A mixture of 70 g of isomalt (IsoMaltidex 16500, Cargill) and 30 g of water was boiled in a preserving jar on a water bath as described in Example 2 to obtain a clear solution. No crystallization occurred upon cooling, and the isomalt solution remained homogeneous for more than 11 days (experiment still running).

### Example 6

100 g of isomalt was boiled in a preserving jar under vacuum without the addition of water to obtain a clear solution. After 12 hours, the vacuum was broken, no crystal formation being observable subsequently for 2 days. This was followed by a phase separation and alteration of the isomalt, the upper third of the solution formed a clear viscid liquid, and the lower two thirds formed a milky white substance with the slightest sandy feeling. Simple stirring yields a homogeneous liquid again.

### Example 7

A mixture of 150 g of erythritol and 80 g of water was boiled for 80 min by the process described in Example 2, and the syrup obtained was slowly cooled to room temperature in a preserving jar while maintaining the vacuum. 120 g of the thus obtained syrup was added to 100 g of edible corn starch in a kneading bowl. Kneading yielded a homogeneous, tight, but formable mass. This mass was transferred to a closed container, a temperature rise to about 35° C. being observed subsequently. After cooling, the mass in the container was solid and hard with a consistency of cocoa butter or baking fat (crumbles easily when pricked with a spoon or knife), which disintegrated into a powder when processed, and produces a slightly cooling, pleasant dissolving feeling in the mouth, with a delicate tender melting feel that is faster and lighter than that of glucose.

This pleasant taste suggests the direct use in sweets, drinks and as a vehicle for medicaments.

### Example 8

By mixing 100 g of an isomalt solution obtained in Example 5 with 80 g of edible corn starch by analogy with Example 7, a homogeneous powder with a taste characteristic of isomalt was obtained.

1. A process for the preparation of stable solutions/syrups of sugar substitutes including:
(a) heating an aqueous solution or suspension of a sugar substitute or a solid sugar substitute for a time and at a temperature sufficient to obtain a clear syrup of the sugar substitute; and
(b) cooling the syrup obtained in step (a) under reduced pressure.

2. The process according to claim 1, wherein said sugar substitute is isomalt or erythritol.

3. The process according to claim 2, wherein said sugar substitute is erythritol, and the content of erythritol in the solution of step (a) is smaller than or equal to 80% by weight.

4. The process according to claim 2, wherein said sugar substitute is isomalt, and:
(i) the content of isomalt in the solution of step (a) is greater than or equal to 50% by weight; or
(ii) solid isomalt is heated directly.

5. The process according to claim 2, wherein said solution is mildly heated to from 80 to 100° C. until a homogeneous syrup is obtained, the solution being heated for 30 to 120 min.

6. The process according to claim 2, wherein said heating is effected by a rapid direct addition of heat.

7. The process according to claim 2, wherein said cooling is effected under reduced pressure by closing the container comprising the heated syrup obtained in step (a).

8. Syrup of a sugar substitute, obtainable by the process described in claim 1.

9. Method of using the syrup of a sugar substitute according to claim 8 for the preparation of base materials and products suitable for the preparation of foods and fodders.

10. Base materials and products obtainable by processing a syrup according to claim 8.
